(19) United States
(12) Patent Application Publication
(10) Pub. No.: US 2013/0318394 A1
(43) Pub. Date: Nov. 28, 2013

(54) EMBEDDED CONTROLLER FIRMWARE MANAGEMENT

(71) Applicant: HON HAI PRECISION INDUSTRY CO., LTD., New Taipei (TW)

(72) Inventors: CHEN-YANG WU, New Taipei (TW); CHIH-HSIUNG HSIEH, New Taipei (TW)

(73) Assignee: HON HAI PRECISION INDUSTRY CO., LTD., New Taipei (TW)

(21) Appl. No.: 13/795,564

(22) Filed: Mar. 12, 2013

(30) Foreign Application Priority Data
May 22, 2012 (TW) 101118149

(51) Int. Cl. G06F 11/14

(52) U.S. Cl. CPC G06F 11/1417
USPC 714/15

(57) ABSTRACT

An embedded controller includes and a microprocessor coupled to the memory. The memory includes a working area for storing embedded controller firmware and a recovery area for storing a copy of the embedded controller firmware. When the embedded controller firmware stored in the working area is corrupt, the microprocessor retrieves the copy of the embedded controller firmware from the recovery area and restores the embedded controller firmware to the working area. The microprocessor can then read and execute the embedded controller firmware from the working area. An embedded controller firmware management method is also provided.

REFERENCE TO RELATED APPLICATIONS

This application claims all benefits accruing under 35 U.S.C. §119 from Taiwan Patent Application No. 101118149, filed on May 22, 2012 in the Taiwan Intellectual Property Office. The contents of the Taiwan Application are hereby incorporated by reference.

### BACKGROUND

1. Technical Field

The disclosure generally relates to an embedded controller and a method for managing embedded controller firmware.

2. Description of Related Art

An embedded controller is a device for use in a general computer, such as a desktop computer or a notebook computer, to control peripheral devices, such as a keyboard or a mouse. The embedded controller typically includes a memory for storing embedded controller firmware, and a microprocessor for executing the controller firmware to implement functionalities of embedded control. However, some operations like firmware update may damage the embedded controller firmware, which may leave whole or part of the notebook computer unusable.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of one embodiment of a computing device equipped with an embedded controller.

FIG. 2 is a block diagram of one embodiment of the embedded controller of FIG. 1.

FIG. 3 is a flowchart showing one embodiment of a method for managing embedded controller firmware.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

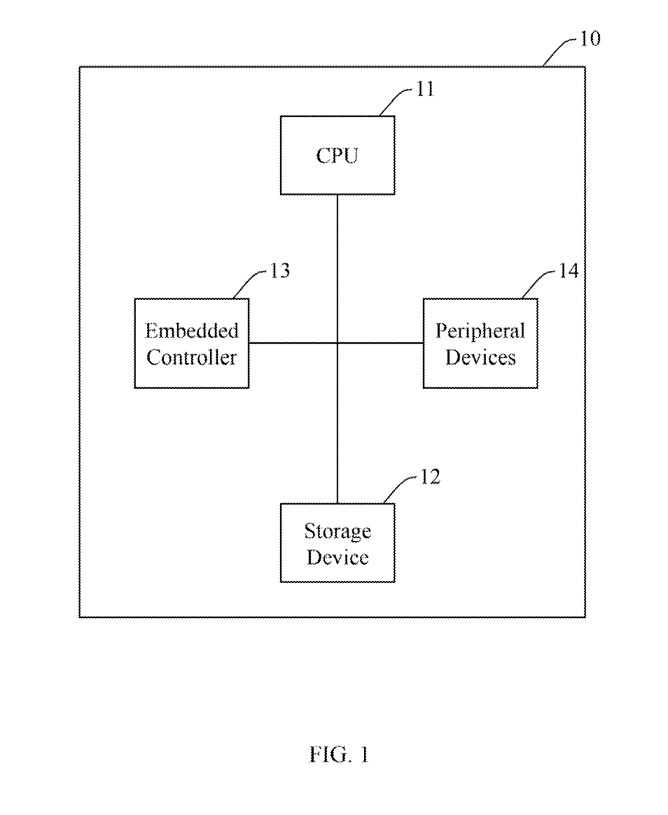

FIG. 1 shows one embodiment of a computing device 10. The computing device 10 includes a central processing unit (CPU) 11, a storage device 12, an embedded controller 13, and peripheral devices 14. The computing device 10 may be a personal computer, a workstation computer, a server computer, a tablet computer, or the like.

The CPU 11 is operably coupled to the storage device 12, the embedded controller 13, and the peripheral devices 14. The CPU 11 may include one or more processors that provide the processing capability to execute the operating system, programs, user and application interfaces, and any other functions of the computing device 10. The CPU 11 may include one or more microprocessors and/or related chip sets. For example, the CPU 11 may include “general purpose” microprocessors, a combination of general and special purpose microprocessors, instruction set processors, graphics processors, video processors, related chips sets, and/or special purpose microprocessors. The CPU 11 also may include onboard memory for caching purposes.

Information, such as programs and/or instructions, used by the CPU 11 may be located within the storage device 12. The storage device 12 may store a variety of information and may be used for various purposes. For example, the storage device 12 may store firmware for the computing device 10 (such as a basic input/output instruction or operating system instructions), various programs, applications, or routines executed on the computing device 10, user interface functions, processor functions, and so forth. In addition, the storage device 12 may be used for buffering or caching during operation of the computing device 10.

The storage device 12 may include any suitable manufacture that includes one or more tangible, computer-readable media. For example, the storage device 12 may include a volatile memory, such as random access memory (RAM), and/or as a non-volatile memory, such as read-only memory (ROM). The components may further include other forms of computer-readable media, such as non-volatile storage, for persistent storage of data and/or instructions. The non-volatile storage may include flash memory, a hard drive, or any other optical, magnetic, and/or solid-state storage media. The non-volatile storage may be used to store firmware, data files, software, wireless connection information, and any other suitable data.

The embedded controller 13 may handle the peripheral devices 14 such as a keyboard, a mouse, a touchpad, a battery, a set of end-user controlled buttons (such as power button and sleep button), or any other relatively slow input/output (I/O) device that should be isolated from the CPU 11 in order to prevent degradation of the overall system performance.

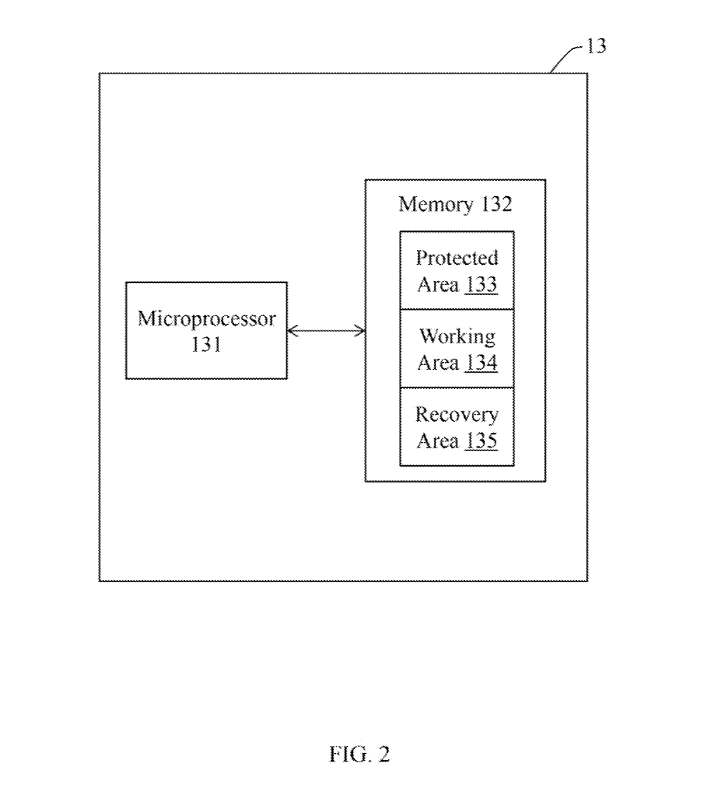

FIG. 2 shows a block diagram of one embodiment of the embedded controller 13. The embedded controller 13 includes a microprocessor 131, and a memory 132. The memory 132 is an electronic non-volatile computer storage device that can be electrically erased and programmed. In some embodiments, the memory 132 is a flash ROM.

The memory 132 is divided into three individual storage areas: a protected area 133, a working area 134, and a recovery area 135. The protected area 133 stores starting address and ending address of each of the working area 134 and the recovery area 135. When the computing device 10 is powered on, the microprocessor 131 immediately sets the protected area 133 as write-protected to protect the data in the protected area 133 from damage. In some embodiments, a size of the protected area 133 is 16 kilobytes.

The working area 134 stores embedded controller operating codes, also known as embedded controller firmware. The microprocessor 131 may read and execute the embedded controller firmware from the working area 134 to implement functionalities of embedded control of the peripheral devices 14. The microprocessor 131 may locate the working area 134 by reading the starting address and the ending address of the working area 134 from the protected area 133. In some embodiments, the working area 134 stores a magic code to indicate the embedded controller firmware stored in the working area 134 is intact.

The recovery area 135 stores a copy of the embedded controller firmware. When the embedded controller firmware stored in the working area 134 is corrupt, the microprocessor 131 may retrieve the copy of the embedded controller firmware from the recovery area 135 and restore the embedded controller firmware to the working area 134. The microprocessor 131 may locate the recovery area 135 by reading the starting address and the ending address of the recovery area 135 from the protected area 133. In some embodiments, when the computing device 10 is powered on, the microprocessor 131 immediately sets the recovery area 135 as write-protected to protect the data in the recovery area 135 from damage.

In other embodiments, the copy of the embedded controller firmware may be compressed into a package and then stored in the recovery area 135 in a form of compressed package to save space of the memory 132. When the microprocessor 131 need restore the embedded controller firmware to the working area 134, the microprocessor 131 need first extract the copy of the embedded controller firmware from the compressed package stored in the recovery area 135.

In a process of firmware update, a magic code may be written into the working area 134 to indicate that the embedded controller firmware has been updated successfully. Specifically, only when whole of the process of firmware update completes successfully, the magic code will be written into the working area 134. If the process of firmware update is interrupted or fails, the magic code will not be written into the working area 134. Thus, the microprocessor 131 may determine whether the embedded controller firmware stored in the working area 134 is corrupt or not by checking whether the magic code exists in the working area 134. If the magic code is found in the working area 134, it is determined that the embedded controller firmware stored in the working area 134 is intact and can be executed by the microprocessor 131. If the magic code cannot be found in the working area 134, it is determined that the embedded controller firmware stored in the working area 134 is corrupt and cannot be executed by the microprocessor 131.

When the embedded controller firmware has been restored to the working area 134 successfully, the microprocessor 131 may further write the magic code to the working area 134. Thus, at the next power-on, the microprocessor 131 may find the magic code in the working area 134 and determine that the embedded controller firmware stored in the working area 134 is intact and can be executed to implement functionalities of embedded control of the peripheral devices 14.

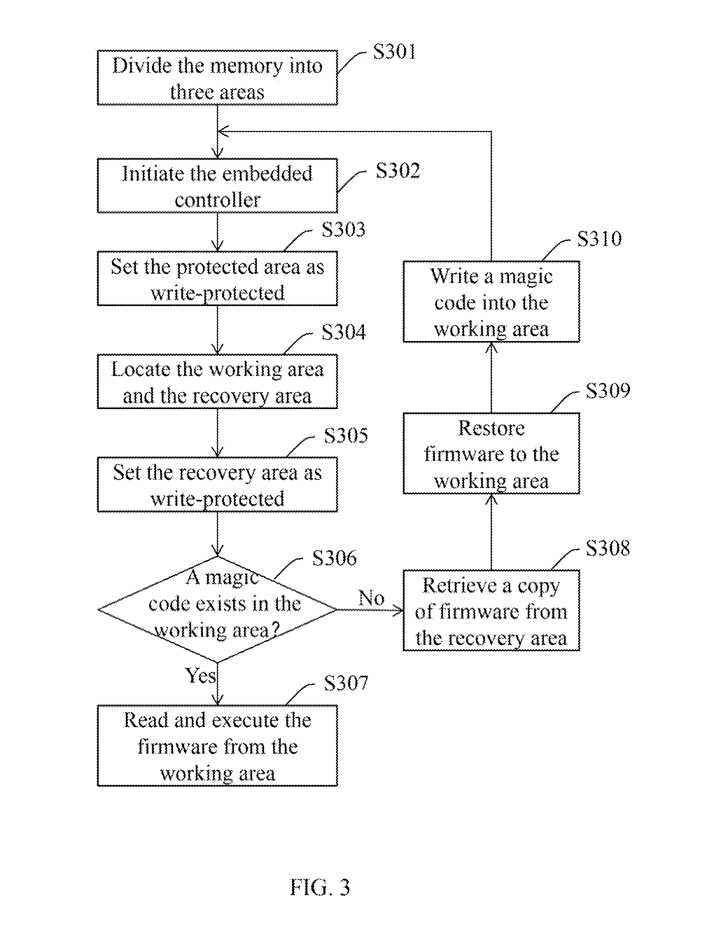

FIG. 3 is a flowchart showing one embodiment of a method for managing embedded controller firmware. The method comprises the following steps.

In step S301, the memory 132 is divided into three individual storage areas: a protected area 133, a working area 134, and a recovery area 135. The protected area 133 stores starting address and ending address of each of the working area 134 and the recovery area 135. In some embodiments, a size of the protected area 133 is 16 kilobytes.

In step S302, when the computing device 10 is powered on or rebooted, the microprocessor 131 is imitated.

In step S303, the microprocessor 131 sets the protected area 133 as write-protected to protect the data in the protected area 133 from damage.

In step S304, the microprocessor 131 locates the working area 134 and the recovery area 135 by reading the starting address and the ending address of the working area 134 and the recovery area 135 from the protected area 133.

In step S305, the microprocessor 131 sets the recovery area 135 as write-protected to protect the data in the recovery area 135 from damage.

In step S306, the microprocessor 131 determines whether the embedded controller firmware stored in the working area 134 is corrupt or not by checking whether a magic code exists in the working area 134. If the magic code is found in the working area 134, it is determined that the embedded controller firmware stored in the working area 134 is intact and the flow goes to S307. If the magic code cannot be found in the working area 134, it is determined that the embedded controller firmware stored in the working area 134 is corrupt and the flow goes to S308.

In step S307, the microprocessor 131 reads and executes the embedded controller firmware from the working area 134 to implement functionalities of embedded control of the peripheral devices 14.

In step S308, the microprocessor 131 retrieves the copy of the embedded controller firmware from the recovery area 135 and restore the embedded controller firmware to the working area 134.

In step S309, the microprocessor 131 restores the embedded controller firmware to the working area 134.

In step S310, the microprocessor 131 writes a magic code into the working area 134. The flow returns to step S302.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. An embedded controller, comprising:
a memory comprising a working area storing embedded controller firmware, and a recovery area storing a copy of the embedded controller firmware; and
a microprocessor coupled to the memory, wherein when the embedded controller firmware stored in the working area is corrupt, the microprocessor is configured to retrieve the copy of the embedded controller firmware from the recovery area and restore the embedded controller firmware to the working area.

2. The embedded controller of claim 1, wherein the memory further comprises a protected area storing location information of the working area and the recovery area.

3. The embedded controller of claim 2, wherein the microprocessor is configured to locate the working area and the recovery area by reading the location information of the working area and the recovery area from the protected area.

4. The embedded controller of claim 2, wherein the microprocessor is configured to set the protected area as write-protected as soon as the embedded controller is initiated.

5. The embedded controller of claim 1, wherein the microprocessor is configured to set the recovery area as write-protected as soon as the embedded controller is initiated.

6. The embedded controller of claim 1, wherein the microprocessor is configured to read and execute the embedded controller firmware from the working area to implement functionalities of embedded control, when the embedded controller firmware stored in the working area is intact.

7. The embedded controller of claim 1, wherein the microprocessor is configured to check whether a magic code exists in the working area, and to determine the embedded controller firmware stored in the working area is corrupt when the magic code does not exist in the working area.

8. The embedded controller of claim 7, wherein the microprocessor is configured to determine the embedded controller firmware stored in the working area is intact when the magic code exists in the working area.

9. The embedded controller of claim 7, wherein the microprocessor is configured to write the magic code into the working area after the embedded controller firmware has been restored to the working area.

10. The embedded controller of claim 7, wherein the microprocessor is configured to obtain a compressed package from the recovery area and extract the copy of the embedded controller firmware from the compressed package, when the embedded controller firmware stored in the working area is corrupt.

11. A method for managing embedded controller firmware, the method comprising:
establishing a working area and a recovery area in a memory of an embedded controller;
storing an embedded controller firmware in the working area and a copy of the embedded controller firmware in the recovery area;
determining whether the embedded controller firmware stored in the working area is corrupt;
when the embedded controller firmware stored in the working area is corrupt, retrieving the copy of the embedded controller firmware from the recovery area and restoring the embedded controller firmware to the working area.

12. The method of claim 11, further comprising:
establishing a protected area in the memory; and
storing location information of the working area and the recovery area in the protected area.

13. The method of claim 12, further comprising locating the working area and the recovery area by reading the location information of the working area and the recovery area from the protected area.

14. The method of claim 12, further comprising setting the protected area as write-protected as soon as the embedded controller is initiated.

15. The method of claim 11, further comprising setting the recovery area as write-protected as soon as the embedded controller is initiated.

16. The method of claim 11, further comprising reading and executing the embedded controller firmware from the working area to implement functionalities of embedded control, when the embedded controller firmware stored in the working area is intact.

17. The method of claim 11, wherein the step of determining whether the embedded controller firmware stored in the working area is corrupt comprises:
checking whether a magic code exists in the working area; and
determining the embedded controller firmware stored in the working area is corrupt when the magic code does not exist in the working area.

18. The method of claim 17, wherein the step of determining whether the embedded controller firmware stored in the working area is corrupt further comprising determining the embedded controller firmware stored in the working area is intact when the magic code exists in the working area.

19. The method of claim 17, further comprising writing the magic code into the working area after the embedded controller firmware has been restored to the working area.

20. The method of claim 17, wherein the step of retrieving the copy of the embedded controller firmware from the recovery area comprises:
obtaining a compressed package from the recovery area; and
extracting the copy of the embedded controller firmware from the compressed package.
